(19) United States
(12) Patent Application Publication
(10) Pub. No.: US 2023/0229651 A1
(43) Pub. Date: Jul. 20, 2023

(54) UPDATING A LOG STRUCTURED MERGED TREE

(71) Applicant: Pliops Ltd., Tel Aviv (IL)

(72) Inventors: Niv Dayan, Tel Aviv (IL); Edward Bortnikov, Tel Aviv (IL); Moshe Twitto, Tel Aviv (IL)

(73) Assignee: Pliops Ltd., Tel Aviv (IL)

(21) Appl. No.: 18/156,362

(22) Filed: Jan. 18, 2023

Related U.S. Application Data
(60) Provisional application No. 63/266,940, filed on Jan. 19, 2022.

(51) Int. Cl. G06F 16/23

(52) U.S. Cl. CPC G06F 16/2358

(57) ABSTRACT

A method for updating a log structured merged (LSM) tree, the method includes (a) performing preemptive full merge operations at first LSM tree levels; and (b) performing capacity triggered merge operations at second LSM tree levels while imposing one or more restrictions; wherein the second LSM tree levels comprise a largest LSM tree level and one or more other second LSM tree levels that are larger from each first LSM tree level; wherein files of the one or more other second LSM tree levels are aligned with files of the largest LSM tree level.

### CROSS REFERENCE

This application claims priority from U.S. Provisional Pat. Serial No. 63/266,940, filing date Jan. 19, 2022, which is incorporated herein by its entirety.

### BACKGROUND

LSM-tree has become the backbone of modern key-value stores and storage engines. It ingests key-value entries inserted by the application by first buffering them in memory. When the buffer fills up, it flushes these entries to storage (typically a flash-based SSD) as a sorted array referred to as a run. LSM-tree then compacts smaller runs into larger ones in order to (1) restrict the number of runs that a query has to search, and to (2) discard obsolete entries, for which newer versions with the same keys have been inserted. LSM-tree organizes these runs based on their ages and sizes across levels of exponentially increasing capacities.

LSM-tree is used widely including in OLTP, HTAP, social graphs, blockchain, stream-processing, etc.

### Compaction Granularity

The compaction policy of an LSM-tree dictates which data to merge when. Existing work has rigorously studied how to tune the eagerness of a compaction policy to strike different trade-offs between the costs of reads, writes, and space. This paper focuses on an orthogonal yet crucial design dimension: compaction granularity. Existing compaction designs can broadly be lumped into two categories with respect to how they granulate compactions: Full Merge and Partial Merge. Each entails a particular shortcoming.

### Partial Merge

With Partial Merge, each run is partitioned into multiple small files of equal sizes. When a level reaches capacity, one file from within that level is selected and merged into files with overlapping key ranges at the next larger level. Partial merge is used by default in LevelDB and RocksDB. Its core problem is high write-amplification. The reason is twofold. Firstly, the files chosen to be merged do not have perfectly overlapping key ranges. Each compaction therefore superfluously rewrites some non-overlapping data. Secondly, concurrent compactions at different levels cause files with different lifespans to become physically interspersed within the SSD. This makes it hard for the SSD to perform efficient internal garbage-collection, especially as the data size increases relative to the available storage capacity.

We illustrate this problem in FIG. 1 with the curve labeled Partial Merge. As shown, write-amplification drastically increases as storage utilization (i.e., user data size divided by storage capacity) increases. FIG. 1 is based on an experiment described in Section 3.

### Full Merge

With Full Merge, entire levels are merged all at once. Full merge is used in Cassandra, HBase, and Universal Compaction in RocksDB. Its core problem is that until a merge operation is finished, the files being merged cannot be disposed of. This means that compacting the LSM-tree’s largest level, which is exponentially larger than the rest, requires having twice as much storage capacity as data until the operation is finished. We illustrate this in FIG. 1 with the curve labeled Full Merge. As shown, this approach is unable to reach a storage utilization of over 50% and thus wastes most of the available storage capacity.

### Research Problem

FIG. 1 shows that existing compaction granulation approaches cannot achieve high storage utilization and moderate write-amplification at the same time. Is it possible to bridge this gap and attain the best of both worlds?

SUMMARY

### BRIEF DESCRIPTION OF THE DRAWINGS

The embodiments of the disclosure will be understood and appreciated more fully from the following detailed description, taken in conjunction with the drawings in which:

FIG. 1 illustrates an example of LSM tree performance;

FIG. 2 illustrates an example of LSM tree policies;

FIGS. 3 illustrates an example of DCA restrictions;

FIGS. 4 illustrates an example of preemptive merge;

FIG. 5 illustrates an example of partial merges;

FIGS. 6A-6B illustrate examples of write amplifications;

FIGS. 7A-7B illustrate examples of write amplifications;

FIG. 8 illustrates an example of restriction of space amplification and write amplification;

FIGS. 9 illustrates examples of improvements of space amplification;

FIGS. 10 illustrates examples of partitioned preemptive merge along larger levels;

FIG. 11 illustrates an example of existing LSM tree designs;

FIG. 12 illustrates an example of existing LSM tree designs;

FIGS. 13A-13H are examples of high storage utilizations;

FIGS. 14A-14D is an example of merge policies;

FIGS. 15 is an example of large files with partial merges;

FIG. 16 is an example of a pseudo code;

FIG. 17 is an example of pseudo code; and

FIG. 18 is an example of a method.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

### DETAILED DESCRIPTION OF THE DRAWINGS

Modern storage engines and key-value stores have come to rely on the log-structured merge-tree (LSM-tree) as their core data structure. LSM-tree operates by gradually sort-merging incoming application data across levels of exponentially increasing capacities in storage.

A crucial design dimension of LSM-tree is its compaction granularity. Some designs perform Full Merge, whereby entire levels get compacted at once. Others perform Partial Merge, whereby smaller groups of files with overlapping key ranges are compacted independently.

This paper shows that both strategies exhibit serious flaws. With Full Merge, space-amplification is exorbitant. The reason is that while compacting the LSM-tree’s largest level, there must be at least twice as much storage space as data to store both the original and new files until the compaction is finished. On the other hand, Partial Merge exhibits excessive write-amplification. The reason is twofold. (1) The files getting compacted typically do not have perfectly overlapping key ranges, and so some non-overlapping data is superfluously rewritten in each compaction. (2) Files with different lifetimes become interspersed within the SSD thus necessitating high overheads for SSD garbage-collection. We show that as the data size grows, these problems get worse.

We introduce Spooky, a new set of compaction granulation techniques to address these problems. Spooky partitions data at the largest level into equally sized files, and it partitions data at smaller levels based on the file boundaries at the largest level. This allows merging one small group of perfectly overlapping files at a time to limit space-amplification and compaction overheads.

At the same time, Spooky performs fewer though larger concurrent sequential writes and deletes to cheapen SSD garbage-collection.

We show empirically that Spooky achieves >2x lower space-amplification than Full Merge and >2x lower write-amplification than Partial Merge at the same time. Spooky therefore allows LSM-tree for the first time to utilize most of the available storage capacity while maintaining moderate write-amplification.

Spooky is a partitioned compaction for Key-Value Stores. Spooky partitions the LSM-tree’s largest level into equally-sized files, and it partitions a few of the subsequent largest levels based on the file boundaries at the largest level. This allows merging one group of perfectly overlapping files at a time to restrict both space-amplification and compaction overheads. At smaller levels, Spooky performs Full Merge to limit write-amplification yet without inflating space requirements as these levels are exponentially smaller. In addition, Spooky writes and deletes data sequentially within each level and across fewer levels at a time. As a result, fewer files become physically interspersed within the SSD to cheapen garbage-collection overheads.

Spooky is a meta-policy: it is orthogonal to design aspects such as compaction eagerness, key-value separation, etc. As such, it both complements and enhances LSM-tree variants such as tiering, leveling, lazy leveling, Wisckey, etc. Hence, Spooky is beneficial across the wide variety of applications/workloads that these myriad LSM-tree instances each optimize for.

### Contributions

Overall, our contributions are as follow.

We show that LSM-tree designs employing Full Merge waste over half of the available storage capacity due to excessive transient space-amplification.

We show that with Partial Merge, SSD garbage-collection overheads increase at an accelerating rate as storage utilization grows due to files with different lifespans becoming interspersed within the SSD. These overheads multiply with compaction overheads to cripple performance.

We introduce Spooky, a new compaction granulation policy that (1) partitions data into perfectly overlapping groups of files that can be merged using little extra space or superfluous work, and (2) that issues SSD-friendly I/O patterns that cheapen SSD garbage-collection.

We show experimentally that Spooky achieves >2x better space-amp than Full Merge and >2x better write-amp than Partial Merge at the same time.

We show that Spooky’s reduced write-amp translates to direct improvements in throughput and latency for both updates and queries.

### LSM-Tree Fundamentals

LSM-tree organizes data across L levels of exponentially increasing capacities. Level 0 is an in-memory buffer (aka memtable). All other levels are in storage. The capacity at Level i is T times larger than at Level i - 1. When the largest level reaches capacity, a new larger level is added. The number of levels L is ≈ logT (N/B), where N is the data size and B is the buffer size.

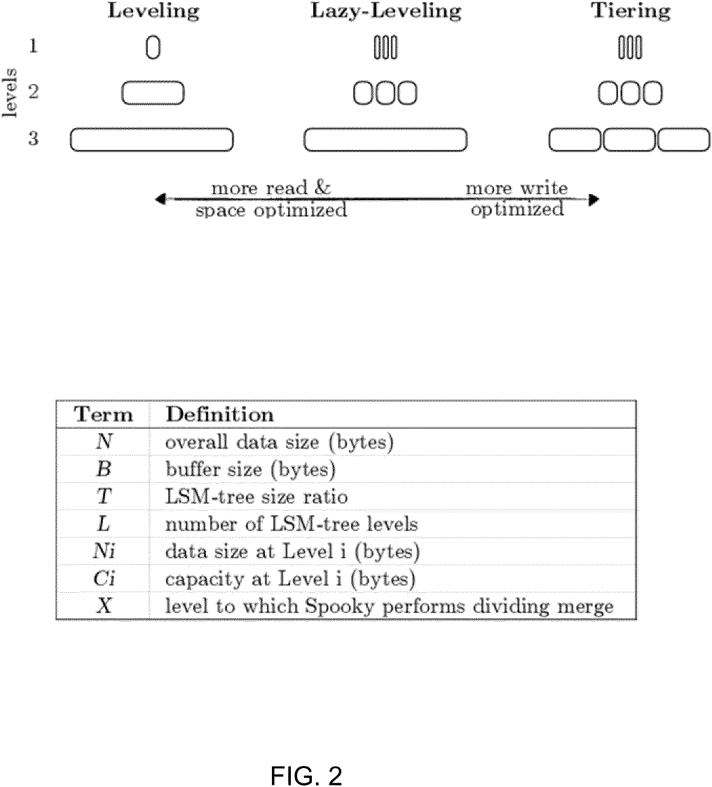

FIG. 2 lists terms used to describe LSM-tree throughout the paper.

For each insert, update, or delete request issued by the application, a data entry comprising a key and a value is put in the buffer (in case of a delete, the value is a tombstone [57]). When the buffer fills up, it gets flushed to Level 1 as a file sorted based on its entries’ keys. Whenever one of the levels in storage reaches capacity, some file from within it is merged into one of the next larger levels.

Whenever two entries with the same key are encountered during compaction, the older one is considered obsolete and discarded. Each file can be thought of as a static B-tree whose internal nodes are cached in memory. There is an in-memory Bloom filter for each file to allow point reads to skip accessing files that do not contain a given key. A point read searches the levels from smallest to largest to find the most recent version of an entry with a given key. A range read sort-merges entries within a specified key range across all levels to return the most recent version of each entry in the range to the user.

### Concurrency Control

LSM-tree has to execute queries, writes, and merge operations concurrently and yet still correctly. In the original LSM-tree paper, each level is a mutable B-tree, and locks are held to transfer data from one B-tree to another when a level reaches capacity. To obviate locking bottlenecks, however, most modern LSM-trees employ multi-version concurrency control.

In RocksDB, for example, a new version object is created after each compaction/flush operation. This version object contains a list of all files active at the instant in time that the compaction/flush finished.

Point and range reads operate over files within the version object that was newest at the instant in time that they commenced to provide a consistent view of the data.

### Space-Amplification

LSM-tree requires more storage space than the size of the raw data. The reason is twofold. First, obsolete entries take up space until compaction discards them. We refer to this as durable space-amplification.

Second, multi-version concurrency control makes it complex to dispose of a file before some compaction that spanned it has terminated. Disposing of files during compaction would require redirecting concurrent reads across different versions of the data and complicate recovery. Instead, all widely-used LSM-tree designs hold on to files until the compaction operating on them is finished. We refer to the temporary extra space needed during compaction to store the original and merged data at the same time as transient space-amplification.

We distinguish between the logical vs. physical size as the LSM tree’s size before and after space-amplification (space-amp) is considered, respectively. The total space-amp is the factor by which the maximum physical data size is greater than the logical data size. We define it in Equation 1 as the sum of durable and transient space-amp plus one. Durable and transient space-amp are each defined here as a fraction of the logical data size. The inverse of total write-amp is storage-utilization, the fraction of the storage device that can store user data. It is generally desirable to reach high storage utilization to take advantage of the available hardware.

$$\text{total space-amp = 1 + transient space-amp + durable space-amp}$$

### Write-Amplification

The LSM-tree’s compactions cause each entry to be rewritten to storage multiple times. The average number of times an entry is physically rewritten is known as write amplification (write-amp). It is generally desirable to keep writeamp low as it consumes storage bandwidth and lifetime.

In addition to compactions, there is another important source of write-amp for LSM-tree: SSD garbage-collection (GC). Modern flash-based SSDs layout data internally in a sequential manner across erase units. As the system fills up, GC takes place to reclaim space for updates by (1) picking an erase unit with ideally little remaining live data, (2) migrating any live data to other erase units, and (3) erasing the target unit. GC contributes to write-amp by causing each write request from the application to be physically rewritten multiple times internally within the SSD.

As GC occurs opaquely within the SSD and has historically been difficult to measure, most work on LSM-tree to date focused exclusively on optimizing write-amp due to compaction. This paper offers the insight that the total writeamp for an LSM-tree is the product of both sources of write-amp as expressed in Equation 2. Both sources must therefore be co-optimized as they amplify each other:

$$\text{total write-amp = compaction write-amp} \times \text{GC write-amp}$$

### Merge Policy

The compaction policy of an LSM-tree determines which data to merge when. The two mainstream policies are known as leveling and tiering, as illustrated in FIG. 2.

With leveling, new data arriving at a level is immediately merged with whichever overlapping data already exists at that level. As a result, each level contains at most one sorted unit of data, also referred to as a run. Each run consists of one or more files.

With tiering, each level contains multiple runs. When a level reaches capacity, all runs within it are merged into a single run at the next larger level. Tiering is more write-optimized than leveling as each compaction spans less data. However, it is less read-efficient as each query has to search more runs per level. It is also less space efficient as it takes longer to identify and discard obsolete entries.

With both leveling and tiering, the size ratio T can be fine-tuned to control the trade-off between compaction overheads on one hand and query and space overheads on the other.

FIG. 2 also illustrates a hybrid policy named lazy leveling, which applies leveling at the largest level and tiering at smaller levels. Its write cost is similar to that of tiering while still having similar space and point read overheads to those of leveling.

It therefore offers good trade-offs in-between. While we focus on leveling in this work for ease of exposition, we also apply Spooky to tiered and hybrid designs to demonstrate its broad applicability.

### Dynamic Capacity Adaptation (DCA)

Durable space-amp exhibits a pathological worst-case. When a new level is added to the LSM-tree to accommodate more data, its capacity is set to be larger by a factor of T than the capacity at the previously largest level.

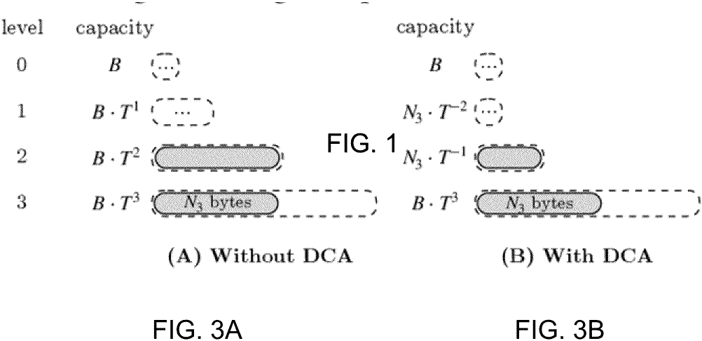

When this happens, the data size at the new largest level is far smaller than its capacity. As the now second largest level fills up with new data, it can come to contain as much data as the current data size at the largest level. In this case, durable space-amp may be two or greater, as illustrated in FIG. 3A. To remedy this, RocksDB introduced a technique coined Dynamic Capacity.

### Adaptation (DCA)

As shown in FIG. 3B, DCA restricts the capacities at Levels 1 to L - 1 based on the data size rather than the capacity at Level L. With leveling or lazy leveling, DCA bounds the worst-case durable space-amp to the expression in Equation 3.

We leverage DCA throughout the paper.

$$\text{durable space-amp} \leq \text{1} / \left(\text{T} - \text{1}\right)$$

### Compaction Granularity

The granularity of compaction controls how much data to merge in one compaction when a level reaches capacity. There are two mainstream approaches: Full vs. Partial Merge. Each has a distinct impact on the balance between write-amp and space-amp in the system.

### Full Merge

With Full Merge, compaction is performed at the granularity of whole levels. Full merge is used in Cassandra, Hbase, and Universal Compaction in RocksDB. Full merge lends itself to preemption, a technique used to reduce write-amp by predicting across how many levels the next merge operation will recurse and merging them all at once.

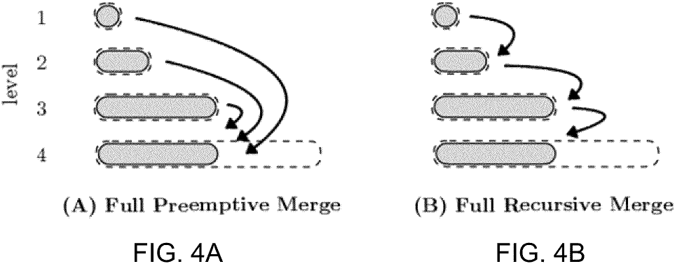

FIG. 4A illustrates an example where Levels 1 to 4, which are all nearly full, are merged all at once. In contrast, 4B shows how without preemption, a merge operation from Level 1 trickles to Level 4, causing data originally at Levels 1 and 2 to be rewritten three and two times, respectively.

We leverage preemption in conjunction with Full Merge throughout the paper to optimize write-amp. The core problem with Full Merge is that while compacting the largest level, which contains most of the data, transient space-amp skyrockets as the original contents cannot be disposed of until the compaction is finished.

### Partial Merge

With Partial Merge, as used by default in LevelDB and RocksDB, each run is partitioned into multiple files (aka Sorted String Tables or SSTs). When Level i fills up, some file from Level I is picked and merged into the files with overlapping key ranges at Level i + 1. Different methods have been proposed for how to pick this file (e.g., randomly or round-robin). The best-known technique, coined ChooseBest, picks the file that overlaps with the least amount of data at the next larger level to minimize write-amp.

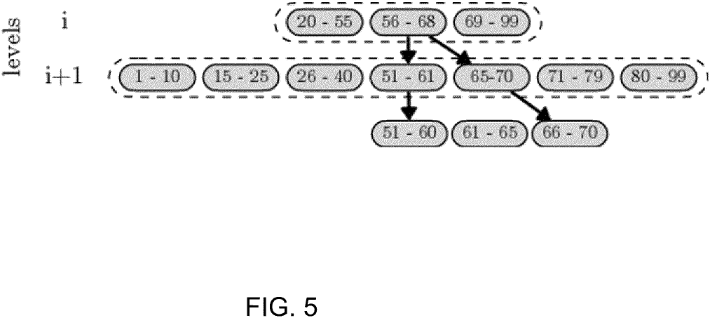

For example, in FIG. 5, the leftmost SST at Level L - 1 overlaps with four SSTs at Level L, the middle with two, and the rightmost with three. Hence, the middle file is picked. Partial Merge exhibits lower transient space-amp than Full Merge as compaction is more granular. However, it exhibits a higher write-amp than Full Merge as we show in the next section.

### 3. Problem Analysis

This section analyzes write-amp and space-amp for Full vs. Partial Merge to formalize the problem. We assume the leveling merge policy for both baselines. We also assume uniformly random insertions to model the worst-case write-amp.

Modeling Compaction Write-Amp. With Full Merge, the i′th run arriving at a level after the level was last empty entails a writeamp of i to merge with the existing run at that level. After T - 1 runs arrive, a preemptive merge spanning this level takes place and empties it again. Hence, each level contributes

$$\frac{1}{T} ∗ {\sum }_{i = 1}^{T - 1} i = \frac{T - 1}{2}$$

to write-amp, resulting in the overall write-amp in Equation 4.

$$\text{compaction write-amp with Full Merge =} \frac{T - 1}{2} ∗ L$$

With Partial Merge, a file picked using ChooseBest from a full Level i intersects with ≈ T/2 files’ worth of data on average at Level i + 1. The overlap among these files typically isn’t perfect, however, leading to additional overhead. For example, in FIG. 5, the file picked from Level L - 1 with key range 56-68 does not perfectly overlap with the two intersecting files at Level L, which have a wider combined key range of 51-70. This means that entries at both edges of the compaction, in the ranges of 51-56 and 68-70, are superfluously rewritten. We coin this problem superfluous edge merging. On average, one additional file’s worth of data is superfluously included in each compaction, leading to the writeamp expression in Equation 5.

$$\text{compaction write-amp with Partial Merge ==} \frac{T + 1}{2} ∗ L$$

### Compaction Write-Amp Experiments

We verify our write-amp models using RocksDB. We use the default RocksDB compaction policy to represent Partial Merge, and we implemented a full preemptive leveled compaction policy within RocksDB 1. The size ratio T is set to 5, the buffer size B to 64 MB, and the rest of the implementation and configuration details are in Sections 5 and 6.

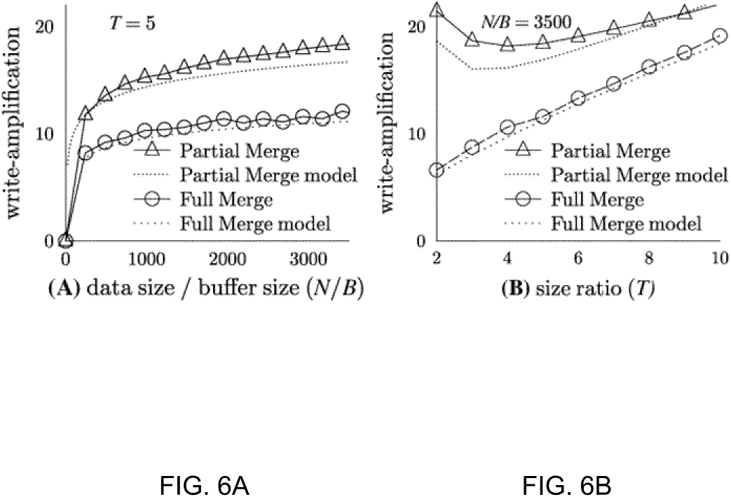

In FIG. 6A, we grow an initially empty database with unique random insertions. The x-axis reports the number of times the buffer has flushed (i.e., N/B), while the y-axis measures compaction write-amp for each baseline against its model predictions. As shown, the models hold up well against reality. We also observe that Full Merge exhibits a lower write-amp than Partial Merge.

The reasons are that (1) it uses preemption to skip merging entries across nearly full levels, and (2) it avoids the problem of superfluous edge merging by compacting whole levels.

FIG. 6B repeats the experiment with different size ratios on the x-axis while instead fixing N/B, the number of times the buffer has flushed, to 3500. The models again hold up well in all settings. We observe that write-amp with Full Merge steadily decreases with smaller size ratios since this reduces the overlap of data across levels. Therefore, for each entry compacted from Level i to Level i + 1, fewer preexisting entries on average at Level i + 1 need to be rewritten. With Partial Merge, however, write-amp cannot be reduced beyond the global minimum value shown in the figure as we decrease the size ratio. The reason is that with smaller size ratios, the relative amount of superfluous work (i.e., rewriting one file’s worth of non-overlapping data) increases relative to the amount of useful work performed in each compaction (i.e., merging ≈ T/2 files’ worth of overlapping data). Hence, Full Merge not only outperforms Partial Merge but is also more amenable to tuning and thus better able to optimize write-amp.

### Garbage-Collection Write-Amp

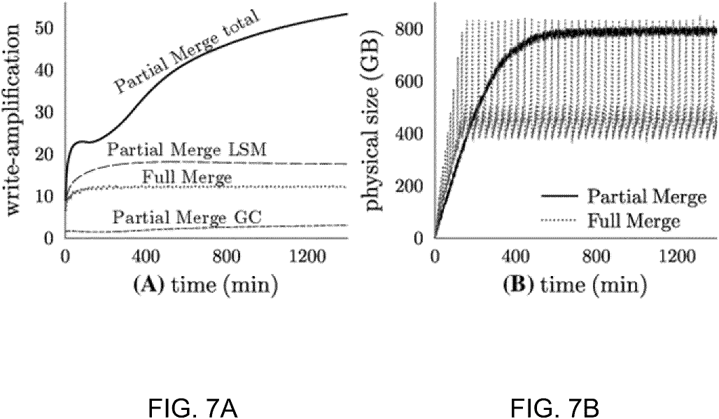

We now analyze the impact of SSD garbage-collection (GC) on write-amp. We run a large-scale experiment that fills up an initially empty LSM-tree with unique random insertions followed by random updates for several hours on a 960 GB SSD. We use the Linux nvme command to report the data volume that the operating system writes to the SSD vs. the data volume that the SSD physically writes to flash. This allows computing GC write-amp throughout the experiment. For both baselines, the size ratio is set to 5, the buffer size to 64 MB, DCA is turned on, and the rest of the setup is given in Section 6. For Full Merge, FIG. 7A only plots write-amp due to compactions as no GC overheads are incurred for this baseline. The reason twofold. First, Full Merge writes one large file at a time. Hence, the SSD erase units that store this large file also get cleared all at once when this file is deleted. This allows the SSD to reclaim space without migrating data internally. Second, Full Merge exhibits high transient space-amp (as discussed more below), which restricts its logical data size to 369 GB in this experiment.

Hence, the SSD is less stressed for space and so GC is less often invoked. For Partial Merge, the logical data size is 644 GB. FIG. 7A plots three curves for its (1) compaction write-amp, (2) GC writeamp, and (3) their product, total write-amp. During the experiment, GC write-amp steadily increases (up to ≈ 3 without having yet converged). The reason is that multiple compactions across different levels occur simultaneously thus causing files to become physically interspersed within the same SSD erase units. Since files from different levels have exponentially varying lifespans, some data in each erase unit is disposed of quickly while other data lingers for much longer. Hence, the SSD must internally migrate older data to reclaim space. This is a manifestation of a well-known problem of “hot” and “cold” data mixing within an SSD to inflate GC overheads. We observe that while GC write-amp is far smaller than compaction write-amp, it multiplies with it to cause total write-amp to inflate to over fifty by the experiment’s end.

It is tempting to think that using larger files with Partial Merge would eliminate these GC overheads by causing larger units of data to be written and erased all at once across SSD erase units. We falsify this notion later in Section 6 by showing that even with large files, GC overheads remain high because concurrent partial compactions still cause files from different levels to mix physically.

### Space-Amp Experiment

For the same experiment in FIG. 7B reports the physical size of each baseline over time. For Full Merge, the curve is sawtooth-shaped.

The reason is that compactions into the LSM-tree’s largest level occasionally cause transient space-amp to skyrocket. In contrast, space-amp with Partial Merge is smooth because compactions occur at a finer granularity. Note that the physical data size for both baselines is similar in this experiment despite the fact that Partial Merge is able to store far more user data. Overall, FIG. 7B demonstrates the core disadvantage of Full Merge: it cannot use of most of the available storage capacity for storing user data.

### Space-Amp Models

We provide space-amp models for Partial vs. Full merge in Equations 6 and 7 to enable an analytical comparison. The term 1/(T–1) in both equations accounts for the worst-case durable space-amp from Equation 3. Otherwise, space-amp with Full Merge is higher by an additive factor of one to account for the fact that its transient space-amp occasionally requires as much extra space as the logical data size. By contrast, transient space-amp with Partial Merge is assumed here to be negligible.

$$\text{space-amp with Partial Merge = 1 +} \text{1} / \left(\text{T-1}\right)$$

$$\text{space-amp with Full Merge = 2 + 1} \left(\text{T-1}\right)$$

FIG. 7B verifies these models. With T set to 5, Equation 6 predicts a physical data size of 805 GB for Partial Merge given a logical data size of 644 GB, and Equation 7 predicts a physical data size of 830 GB for Full Merge given a logical data size of 369 GB.

### Scalability With Data Size

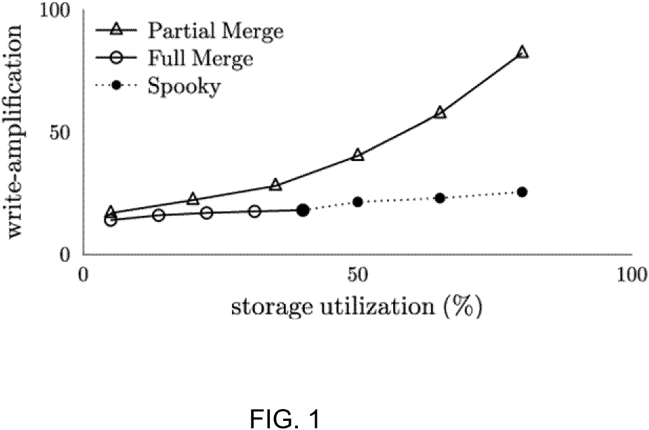

FIG. 1 from the introduction repeats the same experiment as in FIGS. 7A-7B with different logical data sizes. The size ratio is set to ten this time, and we run each trial for at least 24 hours for write-amp to converge. The x-axis reports storage-utilization, and the y-axis measures total write-amp. Full Merge maintains low write-amplification but is unable to reach a storage utilization of over 50%. For Partial Merge, total writeamp increases at an accelerating rate as the logical data size grows.

This is a well-known phenomenon with SSDs: as they fill up, erase blocks with little remaining live data become increasingly hard to find [60]. The outcome is that each additional byte of user data costs disproportionately more to store in terms of performance.

### Problem Statement

Full Merge exhibits exorbitant space-amp while Partial Merge exhibits skyrocketing write-amp as storage utilization increases. We have shown that it is not possible to fix these problems using tuning. First, write-amp due to compactions with Partial Merge cannot be reduced beyond the local minimum shown in FIG. 6B. Second, write-amp due to GC with Partial Merge cannot be eliminated using larger files. Can we devise a new compaction granulation approach that achieves modest space-amp and high storage utilization at the same time?

### 4 Spooky

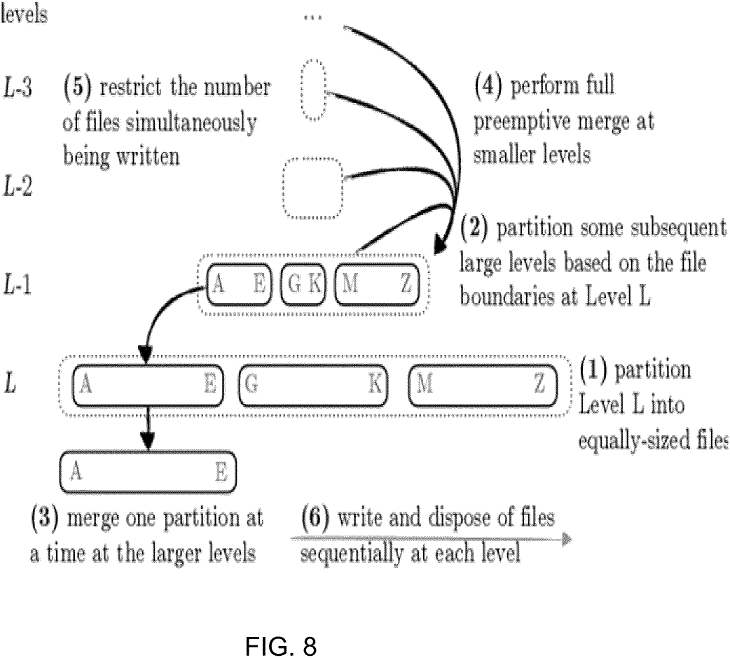

We introduce Spooky, a new method of granulating LSM-tree merge operations that eliminates the contention between write-amp and space-amp. As shown in FIG. 8, Spooky comprises six design decisions. (1) It partitions the largest level into equally-sized files, and (2) it partitions a few of the subsequent largest levels based on the file boundaries at the largest level. (3) This allows Spooky to perform partitioned merge, namely compacting one group of perfectly overlapping files at a time across the largest levels to restrict both write-amp and space-amp. (4) At smaller levels, Spooky performs full preemptive merge. This improves write-amp without harming space-amp as these levels are exponentially smaller. (5) Spooky restricts the number of files being concurrently written to the SSD to limit mixing hot and cold data within the same SSD erase blocks. (6) Within each level, Spooky writes data sequentially and later disposes of it sequentially as well. Hence, large swaths of data written sequentially to the SSD are also deleted sequentially to allow the SSD reclaiming space without internally migrating data.

For ease of exposition, Section 4.1 describes a limited version of Spooky that performs partitioned merge only across the largest two levels. Section 4.2 generalizes Spooky to perform partitioned merge across more levels to enable better write/space trade-offs. Sections 4.3 extends Spooky to accommodate skewed workloads. Sections 4.1 to 4.3 assume the leveling merge policy, while Section 4.4 extends Spooky to tiered and hybrid merge policies.

### 4.1 Two-Level Spooky

Two-Level Spooky (2L-Spooky) performs partitioned merge across the largest two levels of an LSM-tree as shown in FIG. 8.

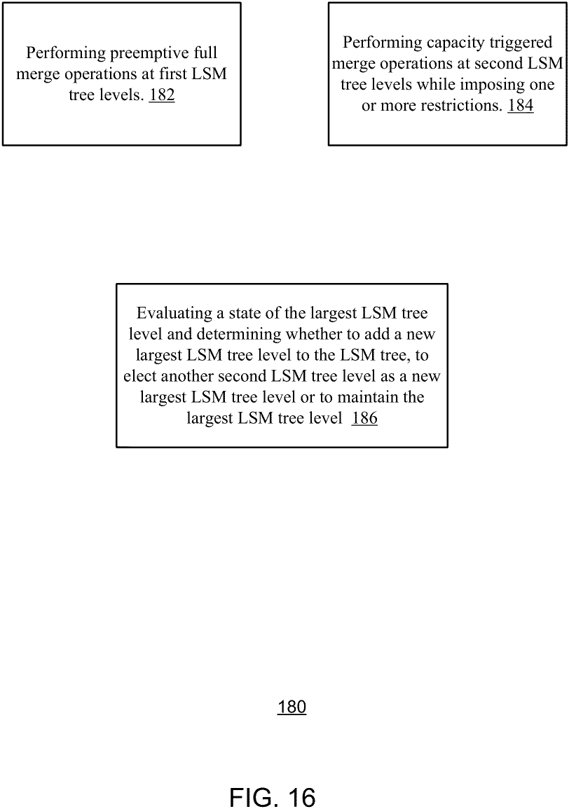

Level L (the largest level) is partitioned into files, each of which comprises at most NL/T bytes, where NL is the data size at Level L and T is the LSM-tree’s size ratio. This divides Level L into at least T files of approximately equal sizes. Level L - 1 (the second largest level) is also partitioned into files such that the key range at each file overlaps with at most one file at Level L. This allows merging one pair of overlapping files at a time across the largest two levels. At Levels 0 to L - 1, 2L-Spooky performs full preemptive merge. FIG. 16 illustrates a pseudo-code of Algorithm 1 of 2L-Spooky’s workflow, which is invoked whenever the buffer fills up and decides which files to merge in response.

### Full Preemptive Merge at Smaller Levels

Algorithm 1 first picks some full preemptive merge operation to perform along Levels 0 to L-1. Specifically, It chooses the smallest level q in the range 1 ≤ q ≤ L - 1 that wouldn’t reach capacity if we merged all data at smaller levels into it (Line 2). It then compacts all data at Levels 0 to q and places the resulting run at Level q (Lines 3-7). Any run at Levels 1 to L - 2 is stored as one file (Line 4).

### Dividing Merge

A merge operation into Level L - 1 is coined a dividing merge. A run written by a dividing merge is partitioned such that each output file perfectly overlaps with at most one file at Level L (Lines 6-7).

### Partitioned Merge

When Level L - 1 reaches capacity (Line 8), 2L-Spooky triggers a partitioned merge. As shown in FIG. 8, this involves merging one pair of overlapping files from Levels L - 1 and L at a time into Level L (Lines 9-11). If the projected size of an output file is greater than NL/T, the output is split into two equally-sized files (Line 10)2. The pairs of files are merged in the order of the keys they contain. This ensures that data is written and disposed of in the same sequential order.

### Evolving the Tree

After a partitioned merge, Algorithm 1 checks if Level L is now at capacity. If so, we add a new level (Lines 13-15). On the other hand, if many deletes took place and the largest level significantly shrank, we remove one level (Lines 56-17). If the number of levels changed, the run at the previously largest level is placed at the new largest level. We then perform dynamic capacity adaptation to restrict durable space-amp (Lines 18-19).

### Write-Amp Analysis

The full preemptive merge operations at smaller levels achieve the modest write-amp of Full Merge across Levels 1 to L - 2. At Level L - 1, each entry is rewritten one extra time relative to pure Full Merge. The reason is that Level L - 1 has to reach capacity before a partitioned merge is triggered (i.e., there is no preemption at Level L - 1). At Level L, the absence of overlap across different pairs of files prevents superfluous rewriting of non-overlapping data and thus keeps write-amp on par with Full Merge.

Hence, 2L-Spooky increases write-amp by an additive factor of one relative to Full Merge, as stated in Equation 8.

$$\text{write-amp with 2L-Spooky = L *} \left(\text{T-1}\right) / 2 + 1$$

### Design for Low SSD Garbage-Collection Overheads

The design of Spooky so far involves at most three files being concurrently written to storage: one due to the buffer flushing, one due to a full preemptive merge, and one due to a partitioned merge. Hence, at most three files can become physically interspersed within the underlying SSD.

In contrast, with Partial Merge, the number of files that can become interspersed in the SSD is unbounded. In addition, Spooky writes data to each level and later disposes of it in the same sequential order. Hence, data that is written sequentially within the SSD is also deleted sequentially. This relaxes SSD garbage-collection as large contiguous storage areas are cleared at the same time. Both of these design aspects help to reduce SSD garbage-collection. We analyze their impact empirically in Section 6.

### Transient Space-Amp Analysis

A dividing merge and a partitioned merge never occur at the same time, yet they are both the bottlenecks in terms of transient space-amp. Hence, transient spaceamp for the system as a whole is lower bounded by the expression max(fileₘₐₓ,CL-1)/NL. The term fileₘₐₓ denotes the maximum file size at Level L and controls transient space-amp for a partitioned merge. The term CL-1 denotes the capacity at Level L - 1 and controls transient space-amp for a dividing merge. Note that while it is possible to decrease fileₘₐₓ to lower transient space-amp for a partitioned merge, the overall transient space-amp would still be lower bounded by CL-1, and so setting fileₘₐₓ to be lower than CL-1 is inconsequential. This explains our motivation for setting fileₘₐₓ to CL-1 = NL/T (Line 10). The overall transient space-amp for 2L-Spooky is therefore 1/T.

### Overall Space-Amp Analysis

By virtue of using dynamic capacity adaptation, Spooky’s durable space-amp is upper-bounded by Equation 3. We plug this expression along with Spooky’s transient space-amp of 1/T into Equation 1 to obtain Spooky’s overall worst-case space-amp in Equation 9.

$$\text{space-amp with 2L-Spooky = 1 +} 1 / \text{T} \text{+ 1} \left(\text{T-1}\right)$$

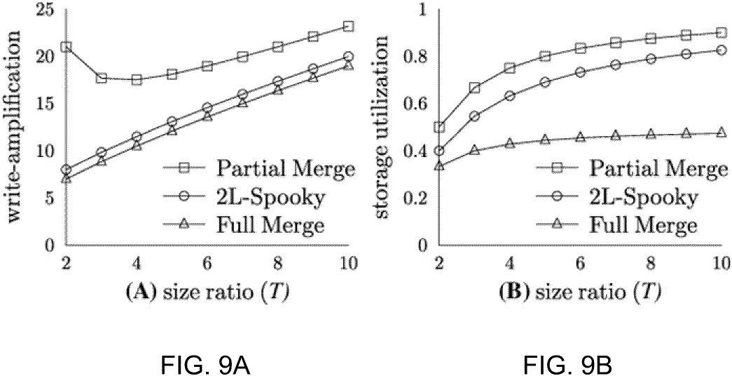

FIG. 9A plots 2L-Spooky’s write-amp against Full and Partial Merge (Eqs. 5, 4, and 8) as we vary the size ratio. The data size N is assumed to be 1 TB while the buffer size B is 64 MB.

2L-Spooky significantly reduces write-amp relative to Partial Merge while almost matching Full Merge. Note that the figure ignores the impact of SSD garbage-collection and therefore understates the overall write-amp differences between the baselines.

FIG. 9B plots space-utilization, the inverse of space-amp, for all three baselines (Eqs. 7, 6 and 9). 2L-Spooky improves space utilization compared with Full Merge by 10% to 30% depending on the tuning of T. Compared with partial merge, however, space utilization with 2L-Spooky is ≈ 10% worse across the board.

In summary, while 2L-Spooky enables new attractive write/space cost balances, its write-amp is still higher than with Full Merge by one and it’s space-utilization is higher than with Partial Merge by ≈ 10%. It therefore does not dominate either of these baselines and leaves something to be desired. We improve it further in Section 4.2.

### 4.2 Generalizing Spooky for Better Trade-Offs

In Section 4.1, we saw that the dividing merge operations into Level L - 1 creates a lower bound of 1/T over transient space-amp. The reason is that Level L - 1 contains a fraction of 1/T of the raw data, and it is rewritten from scratch during each dividing merge operation. In this section, we generalize Spooky to support dividing merge operations into smaller levels to overcome this lower bound.

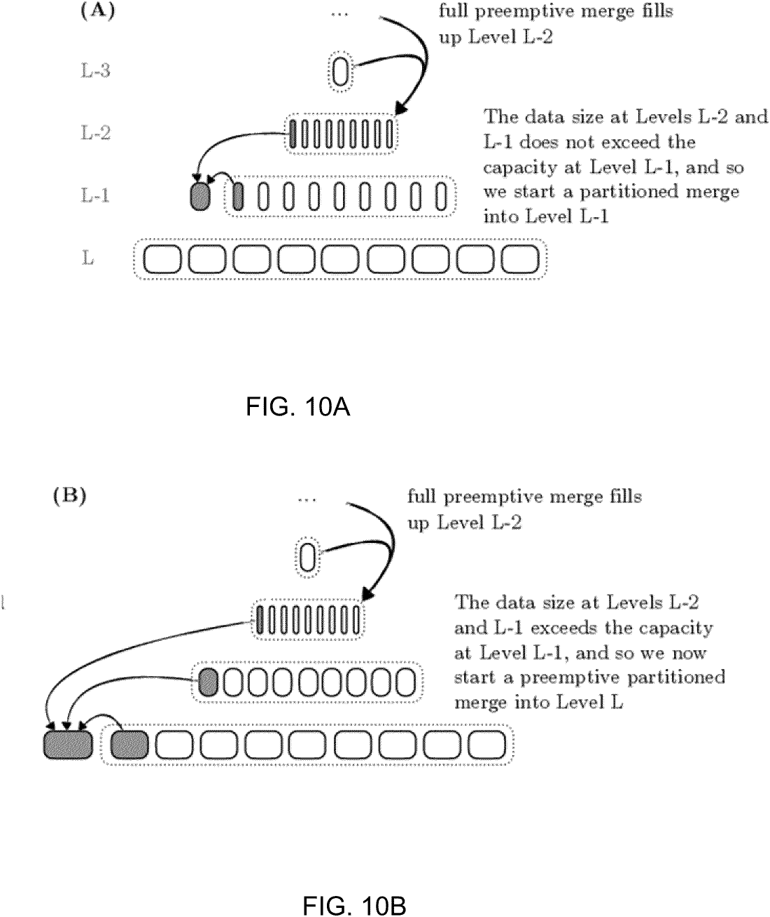

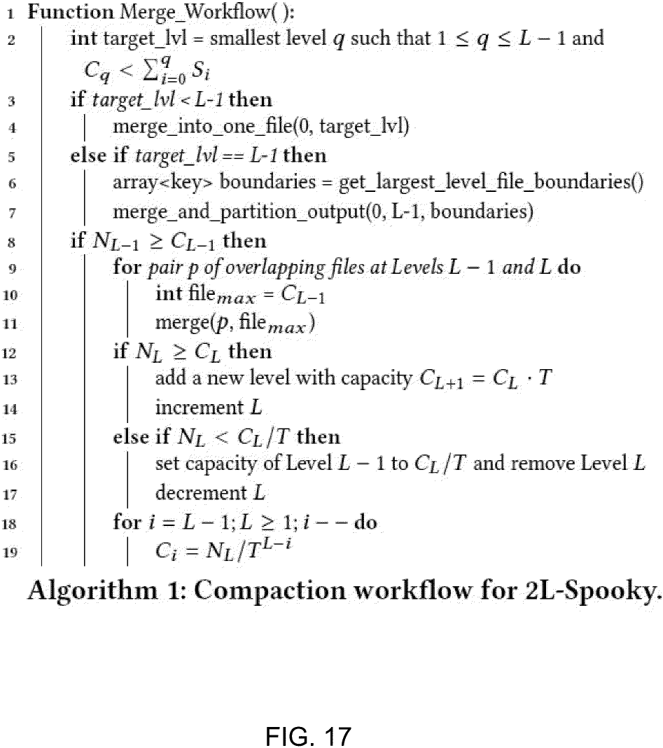

FIG. 17 illustrates Algorithm 2 which is a pseudo-code of Spooky’s generalized compaction workflow. The workflow takes a parameter X, which determines the level into which we perform dividing merge operations. Level X is the smallest level at which we start partitioning runs based on the file boundaries at Level L (the largest level). For example, X, is set to L - 1 in FIG. 8 and to L - 2 in FIG. 10. Level L is now partitioned into files whose sizes are dictated by the capacity at Level X (i.e., at most CX = NL/T L-X bytes each). X may be selected in any manner.

### Merging at Smaller Levels

Algorithm 2 is different from Algorithm 1 in that full preemptive merge operations only take place along levels 0 to X - 1 while dividing merge operations now take place into Level X (rather than into Level L - 1 as before). All else is the same as in Algorithm 1.

### Partitioned Preemptive Merge

When Level X fills up, Spooky performs a partitioned merge operation along the largest L - X levels, one group of at most L - X perfectly overlapping files at a time. An important design decision in the generalized workflow is to combine the idea preemption with partitioned merge to limit writeamp emanating from larger levels. Specifically, when Level X is full, Algorithm 2 picks the smallest level z in the range X + 1 ≤ z ≤ L that would not reach capacity if we merged all data within this range of levels into it (Line 9). Then, one group of overlapping files across Levels X to z is merged at a time into Level z. If the target level z is not the largest level, the resulting run is partitioned based on the file boundaries at the largest level (Lines 11-12) to facilitate future partitioned merge operations.

In FIG. 10A, for example, the cumulative data size at Levels L - 2 and L - 1 does not exceed the capacity at Level L - 1, and so we merge one pair of files from Levels L - 2 and L - 1 at a time into Level L - 1. InB, however, the data size at Levels L - 2 and L - 1 does exceed the capacity at Level L - 1, and so Level L is chosen as a the target. We therefore merge three overlapping files from Levels L - 2, L - 1 and L at a time into Level L. In this case, preemption allows us to merge the data from Level L - 2 once rather than twice on the way to Level L.

### Write-Amp Analysis

At Levels 1 to X - 1, full preemptive merge operations keep write-amp on par with our Full Merge baseline. At Level X, each entry is rewritten one extra time on average relative to Full Merge as there is no preemption at this level. At Levels X + 1 to L, write-amp is the same as with Full Merge as we effectively perform full preemptive merge across groups of perfectly overlapping files. Hence, the overall write-amp so far is the same as before for 2L-Spooky in Equation 8. Interestingly, note that by setting X to Level 0, Spooky divides data within the buffer based on the file boundaries at Level L and thus performs partitioned preemptive merge across the whole LSMtree. In this case, the additional write-amp overhead of Level X is removed. We did not implement this feature, yet it allows Spooky’s overall write-amp to be summarized in Equation 10.

$$\begin{matrix}\text{write-amp with Spooky} \text{=} \\ \text{L*} \left(\text{T-1}\right) / 2 + \left\{\begin{matrix}0 i f X = 0 \\ 1 i f X i s b e t w e e n 1 a n d L - 1\end{matrix}\right)\end{matrix}$$

### Overall Space-Amp Analysis

A partitioned merge entails a transient space-amp of at most

$$\frac{1}{{T}^{L - x}}$$

as Level L is partitioned into at least T^{L-X} files of approximately equal sizes. A dividing merge operation also entails a transient space-amp of

$$\frac{1}{{T}^{L - x}}$$

as the capacity as this level is a fraction of

$$\frac{1}{{T}^{L - x}}$$

of the raw data size. The overall transient space-amp, which is the maximum of these two expressions, is therefore also

$$\frac{1}{{T}^{L - x}}$$

. By plugging this expression along with Equation 3 for durable space-amp into Equation 1, we obtain Spooky’s overall space-amp in Equation 11

$$\text{space-amp with Spooky} = 1 + \frac{1}{{T}^{L - X}} + \frac{1}{T - 1}$$

### Query Costs

Spooky does not alter the number of levels in the LSM-tree, which remains L ≈ logT (N/B). Hence, it does not affect queries, which in the worst-case have to access every level. Query performance is therefore orthogonal to this work.

### Dominating Space/Write Trade-Offs

Equation 11 indicates that by performing partitioned merge across more levels (i.e.., by reducing X), transient space-amp with Spooky becomes negligible and approaches the space-amp of Partial Merge. At the same time, Spooky significantly reduces write-amp relative to Partial Merge.

Thus, Spooky dominates Partial Merge across the board. Relative to Full Merge, Spooky increases write-amp by a modest additive factor of one, and this factor can in fact also be saved by setting X to Level 0. At the same time, Spooky offers far lower spaceamp than with Full Merge and thus allows to exploit much more of the available storage capacity. Hence, Spooky offers dominating trade-offs relative to Full Merge as well.

### 4.3 Optimizing for Skew

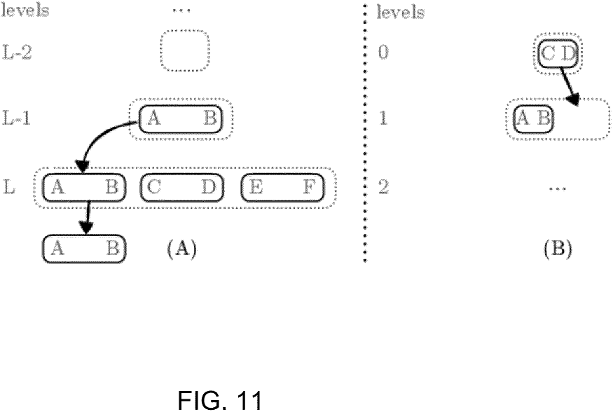

So far, we have been analyzing Spooky under the assumption of uniformly random updates to reason about worst-care behavior and thus quality of service guarantees. Under skewed updates, which are the more common workload, Spooky has additional advantages. Spooky naturally optimizes for skewed update patterns by avoiding having to rewrite files at the largest level that do not overlap with newer updates. For instance, in FIG. 11A, we see an example whereby all new data at Level L-l is skewed and thus only intersects with one of the files at Level L. Hence, we do not need to rewrite the rest of the files. This is in contrast to Full Merge, which stores all data at Level L as one file and would therefore have to rewrite the whole level. Hence, while Spooky is able to match Full Merge in the worst-case, in fact significantly improves on it in the more common skewed case.

An additional possible optimization is to divide data at smaller levels into smaller files, just so that during a full preemptive merge, we can skip merging some files that do not have any other overlapping files. In FIG. 11A, for instance, the buffer is flushed into Level 0, but since the new contents at the buffer do not intersect with the existing file at Level 0, they are simply flushed as a new small file. This optimization is particularly useful for accommodating sequential writes in the key space efficiently.

### 4.4 Supporting Tiered & Hybrid Merge Policies

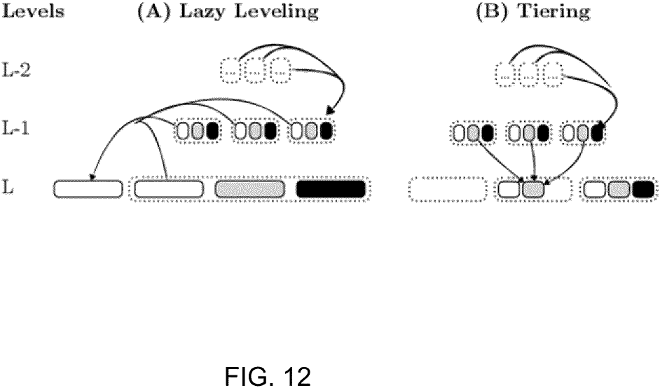

While we have focused so far on how to apply Spooky on top of the leveling merge policy, it is straight-forward to apply Spooky on top of tiering and hybrid policies as well. FIG. 12A shows how to do so with lazy leveling, which has one run containing most of the data at the largest level and multiple runs at each of the smaller levels. In this example, we assume 2L-Spooky to visualize the core idea clearly, and each shading corresponds to a disjoint part of the key space. The key idea here is to partition each run based on the file boundaries at the largest level. During a partitioned merge (i.e., after Level X fills up), we draw from each run at Level

FIG. 12B shows how to apply Spooky to pure tiering. In this case, the largest level consists of multiple runs, and the data at Level L - 1 is partitioned based on the file boundaries at the oldest run at Level L. During each partitioned merge, we fill up one run at Level L by merging one group of overlapping files from level L - 1 at a time. When Level L reaches capacity, we can merge one group of perfectly overlapping files from Level L.

### 5 Implementation

This section discusses Spooky’s implementation within RocksDB. Encapsulation. There is an abstract compaction_picker.h class within RocksDB. Its role is to implement the logic of which files to compact under which conditions and how to partition the output into new files.We implemented Spooky by inheriting from this class and implementing the logic of Algorithm 2. Our implementation is therefore encapsulated in one file. This highlights an advantage of Spooky from an engineering perspective as it leaves all other system aspects (e.g., recovery, concurrency control, etc.) unchanged.

rLevels. We refer to levels in the RocksDB implementation as rLevels to prevent ambiguity with levels in our LSM-tree formalization introduced in Section 2.

rLevel 0. In RocksDB, rLevel 0 is the first rLevel in storage, and it is special: it is the only rLevel whose constituent files may overlap in terms off the keys they contain. When rLevel 0 has accrued α files flushed from the buffer, the compaction picker, and hence our Algorithm 2, is invoked. Once there are β files at rLevel 0, write throttling is turned on. When there are γ files at rLevel 0, the system stalls to allow ongoing compactions to finish. We tune these parameters to α = 4, β = 4 and γ = 9 throughout our experiments. Note that in effect, rLevel 0 can be seen as an extension of the buffer, and so it loosely corresponds to Level 0 in our LSM-tree formalization from Section 2. Flushing the buffer to rLevel 0 contributes an additive factor of one to write-amp, and so our implementation has a higher write-amp by one than the earlier write-models models (in Eqs. 8 and 10).

Level to rLevel Mappings. In RocksDB, all rLevels except rLevel 0 can only store one run (i.e., a non-overlapping collection of files). In order to support tiered and hybrid merge policies, whereby each level can contain multiple runs, we had to overcome this constraint. We did so by mapping each level in our LSM-tree formalization to one or more consecutive RocksDB rLevels. For example, in a tiered merge policy, Level 1 in our formalization corresponds to rLevels 1 to T, Level 2 to rLevels T + 1 to 2T, etc.

Assuming Tiered/Hybrid Merge Policies. Our implementation has a parameter G for the number of greedy levels from largest to smallest that employ the leveling merge policy. Hence, when G ≥ L, we have pure leveling, when G = 0 we have pure tiering, and when G = 1 we have lazy leveling. Thus, our implementation is able to assume different merge policies to assume different trade-offs for different application scenarios. The size ratio T can further be varied to fine-tune these trade-offs.

### Full Merge.

For our full merge baseline, we use our Spooky implementation yet with partitioned merge turned off. Hence, full preemptive merge is performed across all levels.

### Avoiding Stalling.

RocksDB’s default compaction policy is able to perform internal rLevel 0 compactions, whereby multiple files at rLevel 0 are compacted into a single file that gets placed back at Level 0. The goal is to prevent the system from stalling when rLevel 0 is full (i.e., has γ files) yet there is an ongoing compaction into rLevel 1 that must finish before we trigger a new compaction from rLevel 0 to rLevel 1. We also enable rLevel 0 compactions within our Spooky implementation to prevent stalling.

Specifically, whenever a full preemptive merge is taking place and we already have α or more files of approximately equal sizes, created consecutively, and not currently being merged, we compact these files into one file, which gets placed back at rLevel 0.

### Concurrency

Our implementation follows RocksDB in that each compaction runs on background thread/s. We use the sub-compaction feature of RocksDB to partition large compactions across multiple threads. Our design allows for partitioned compactions, full preemptive compactions, and Level 0 compactions to run concurrently.

Hence, there can be at most three compactions running simultaneously, though each of these compactions may be further parallelized using sub-compactions.

### 6 Evaluation

We now turn to evaluate Spooky against Full and Partial Merge. Platform. Our machine has an 11th Gen Intel i7-11700 CPU with sixteen 2.50 GHz cores. The memory hierarchy consists of 48 KB of L1 cache, 512 KB of L2 cache, 16 MB of L3 cache, and 64 GB of DDR memory. An Ubuntu 18.04.4 LTS operating system is installed on a 240 GB KIOXIA EXCERIA SATA SSD. The experiments are running on a 960 GB Samsung NVME SSD model MZ1L2960HCJR-00A07 with the ext4 file system.

### Setup

We use db_bench to run all experiments as it is the standard tool used to benchmark RocksDB at Meta and beyond. Every entry consists of a randomly generated 16 B key and a 512 B value. Unless otherwise mentioned, all baselines use the leveling merge policy, a size ratio of 5, and a memtable size of 64 MB. Bloom filters are enabled and assigned 10 bits per entry. Dynamic capacity adaptation is always applied for all baselines. The data block size is 4 KB. We use one application thread to issue inserts/updates, and we employ sixteen background threads to parallelize compactions.

We use the implementation from Section 5 to represent Spooky and Full Merge. For Spooky, we set the parameter X, the level into which Spooky performs dividing merge operations, to L - 2, the third largest level. For Partial Merge, we use the default compaction policy of RocksDB with a file size of 64 MB.

### Experimental Control

Prior to each experimental trial, we delete the database from the previous trial and reset the drive using the fstrim command. This allows the SSD to reclaim space internally. We then fill up the drive from scratch for the next trial. This methodology ensures that subsequent trials do not impact each other.

### System Monitoring

We run the du Linux command to monitor the physical database size every five seconds. We also run the nvme command every two minutes to report the the SSD’s internal garbage-collection write-amp. We use RocksDB’s internal statistics to report the number of bytes flushed and compacted every two minutes to allow computing write-amp due to compactions. We use db_bench to report statistics on throughput and latency.

### Spooky Enables High Storage Utilization.

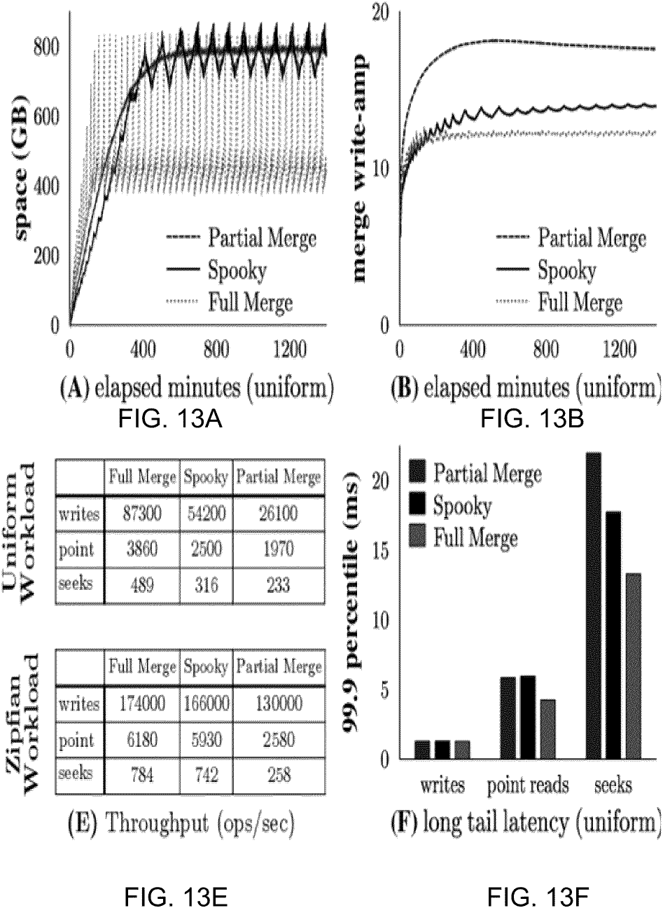

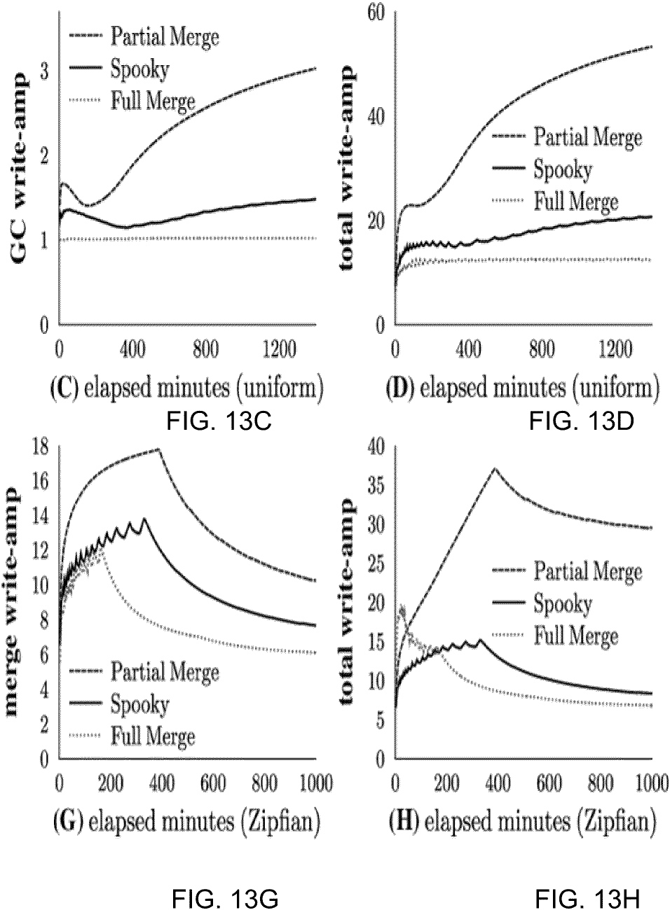

FIGS. 13A-13H show results from a large-scale experiment running for one day for each baseline. In each trial, we fill up a baseline with unique random insertions followed by random updates. InA, the x-axis measures elapsed time while the y-axis measures each baseline’s physical data size. Full Merge and Partial Merge behave as we already saw in Section 3. Full Merge exhibits a sawtooth-shaped curve due to its massive transient space-amp. It can therefore support a smaller logical data size (369 GB in this experiment). In contrast, Partial Merge exhibits negligible transient space-amp, and so it can store more logical data (644 GB in this case). For Spooky, the curve is also sawtooth-shaped, where each tooth corresponds to the transient space-amp needed for a partitioned merge operation. However, the teeth are significantly smaller due to the finer granularity of partitioned merge. This allows Spooky to match Partial Merge in terms of logical data size.

### Spooky Reduces Compaction Overheads

FIG. 13B measures write-amp due to compaction operations. Write-amp with Spooky is higher than with Full Merge by an additive factor of one by design, and even slightly higher since Spooky stores more logical data. At the same time, Spooky significantly improves write-amp relative to Partial Merge. The reason is that unlike Partial Merge, Spooky avoids superfluous edge merging by performing full merge at smaller levels and by compacting perfectly overlapping files at larger levels. Furthermore, Spooky performs merge preemption across most levels to avoid rewriting entries at nearly full levels.

### Spooky Reduces Garbage-Collection

FIG. 13C measures the SSD’s garbage-collection overheads over time. Full Merge exhibits no overheads since all writes and deletes are large and sequential, and because the data size is smaller so the SSD is not stressed for free space. Partial Merge exhibits the highest overheads because its multiple concurrent small compactions cause many files with different lifespans to become interspersed within the same SSD erase units. This prevents the SSD from cheaply reclaiming space. With Spooky, garbage-collection is significantly cheaper than with Partial Merge. The reason is that Spooky writes fewer though larger files concurrently. This leads to less interspersing of files with disparate lifespans within the SSD.

### Spooky Reduces Total Write-Amp

FIG. 13D reports total write-up, the product of the write-amps due to compaction and garbage-collection from 13B and 13C. With Full Merge, total write-amp is lowest, though the trade-off is significantly lower storage utilization as we saw inA. With Partial Merge, the higher compaction and garbage-collection overheads multiply each other to result in a total write-amp of over fifty without having yet converged. Spooky dominates Partial Merge by reducing total write-amp by ≈ x2.5 while matching it in terms of logical data size.

### Spooky Enables Better Write Performance

The left-most set of bars in FIG. 13E compares update throughput for the three baselines. Since the y-axis is log-scale, the figure also provide the factors by which Spooky and Full Merge improve on Partial Merge on top of each bar. Furthermore, FIG. 13F reports the mean update latency for each baseline, while the error bars indicate one standard deviation. Spooky and Full Merge improve update throughput and latency relative to partial merge by approximately the same factors by which they reduce total write-amp relative to Partial Merge. This demonstrates that reductions in total write-amp translate to direct improvements in write performance.

### Spooky Improves Query Performance

We continue the experiment by adding one application thread to issue queries in parallel to the thread issuing updates. We first issue point reads for two hours and then seeks (i.e., short scans) for two hours. Throughput for the querying thread is reported in FIG. 13E while latency is reported in 13G and 13H. Since Spooky and Partial Merge have the same data size, the same number of levels, and identically tuned Bloom filters, we might have expected their query performance is also identical. We instead observe that Spooky significantly improves query performance. The reason for the discrepancy is the background update thread, which generates a higher write-amp with Partial Merge that impedes query performance. Full Merge exhibits the best querying performance due to its lowest background write-amp, yet the trade-off is its inability to exploit the available storage capacity. Overall, Spooky nearly matches Full Merge in query performance while accommodating ≈ 2x more logical data.

### Larger Files Only Slightly Improve Partial Merge

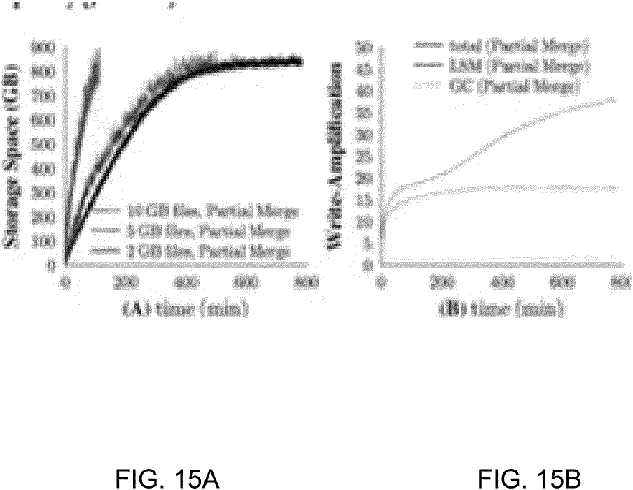

It is tempting to think that using larger files with Partial Merge would eliminate GC overheads by causing larger units of data to be written and erased all at once across SSD erase units. In FIG. 15A, we try three large file sizes. With 10 GB and 5 GB files, the database crashed after exceeding the SSD storage capacity, and so the respective curves are incomplete. The reason is that larger files entail higher transient space-amp that causes the physical data size to vary widely, as evidenced by the noisier curves. Since 2 GB files were the largest we succeeded in finishing the experiment with, we measure write-amp for Partial Merge with 2 GB files in FIG. 15B. GC overheads are slightly lower than in FIG. 13C, which uses 64 MB files. However, these overheads are still considerable and result in higher total write-amp than with Spooky. The reason is that even with 2 GB files, concurrent compactions still cause these files to become physical interspersed. Furthermore, our SSD’s erase units are likely larger than 2 GB and thus exacerbate this problem. Overall, the GC with Partial Merge is not a tuning issue but rather an intrinsic problem, to which Spooky offers a solution.

### Spooky Is Widely Applicable

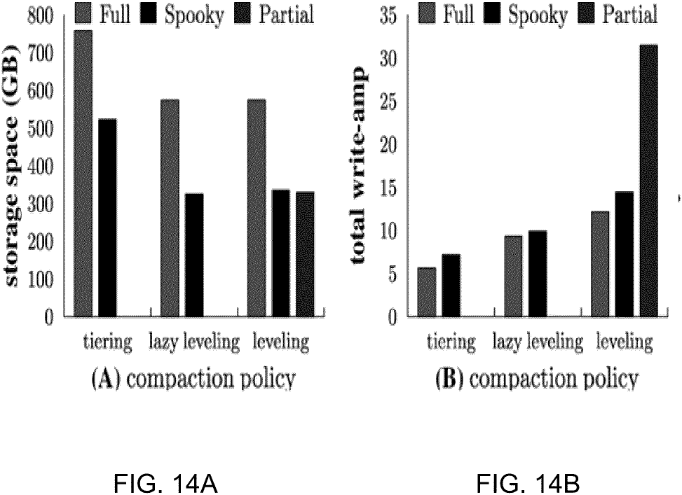

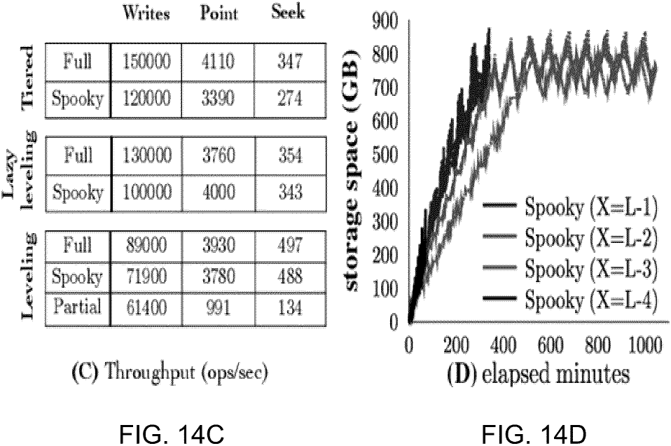

In FIGS. 14A-14B, we demonstrate Spooky’s benefits across more merge policies and tunings. There are four Spooky baselines: Leveling and Lazy Leveling, each with size ratios T = 5 and T = 10. To recap, Lazy Leveling trades seek performance to reduce write-amp by relaxing merging at smaller levels, while larger size ratios reduce space-amp but entail higher write-amp. For the baselines with T = 10 we use a larger logical data size of 750 GB. Overall, these four baselines represent Spooky instances suitable for a diverse range of applications. We also provide results for Partial Merge with size ratios T = 5 and T = 10 to highlight the best competition from RocksDB5.

FIGS. 14A and 14B shows that the Spooky baselines consistently improve write-amp and update throughput relative to Full Merge. We also observe that the Lazy Leveling baseline with Spooky further optimizes these metrics compared to leveling. In FIG. 14C, we observe significantly better point read throughput with the Spooky baselines due to the reduction of background write-amp.

Lazy Leveling is competitive with Leveling under Spooky despite having more runs in the system as the Bloom filters help skipping most runs. In FIG. 14D, which measures seek throughput, the lazy leveling instances do not perform as well because the seeks suffer from having to access more runs in storage. However, we again observe that Leveled Spooky offers far faster seeks than Leveled Partial Merge because it eliminates background write-amp. Overall, we observe that Spooky is applicable across a wide range of LSM-tree variants that optimize for diverse application workloads and space requirements.

We have seen that Spooky matches Partial Merge in terms of storage utilization while significantly beating it in terms of write-amp and query/update performance. Thus, Spooky dominates Partial Merge across the board. At the same time, Spooky is competitive with Full Merge while increasing storage utilization by ≈ 2x. Thus, Spooky is the first merge granulation approach to allow LSM-tree to maintain moderate write-amp as it approaches device capacity.

Key-Value Separation. Recent work proposes to store the values of data entries in an external log or in a separate tiered LSM-tree. This improves write-amp while sacrificing scan performance. Spooky can be combined with the LSM-tree component/s in such designs for better write-amp vs. space-amp balances.

In-Memory Optimizations. Various optimizations have been proposed for LSM-tree’s in-memory data structures including adaptive or learned caching, leaned fence pointers, tiered buffering, selective flushing, smarter Bloom filters or replacements thereof, and materialized indexes for scans. Spooky is fully complementary with such works as it only impacts the decision of which files to merge and how to partition the output.

Performance Stability. Recent work focuses on maintaining stable performance during compaction operations. Various prioritization, synchronization, deamortization, and throttling techniques have been proposed. Our Spooky implementation on RocksDB performs compaction on concurrent threads to avoid blocking the application, yet it could benefit from these more advanced techniques to more evenly schedule the overheads of large compaction operations in time.

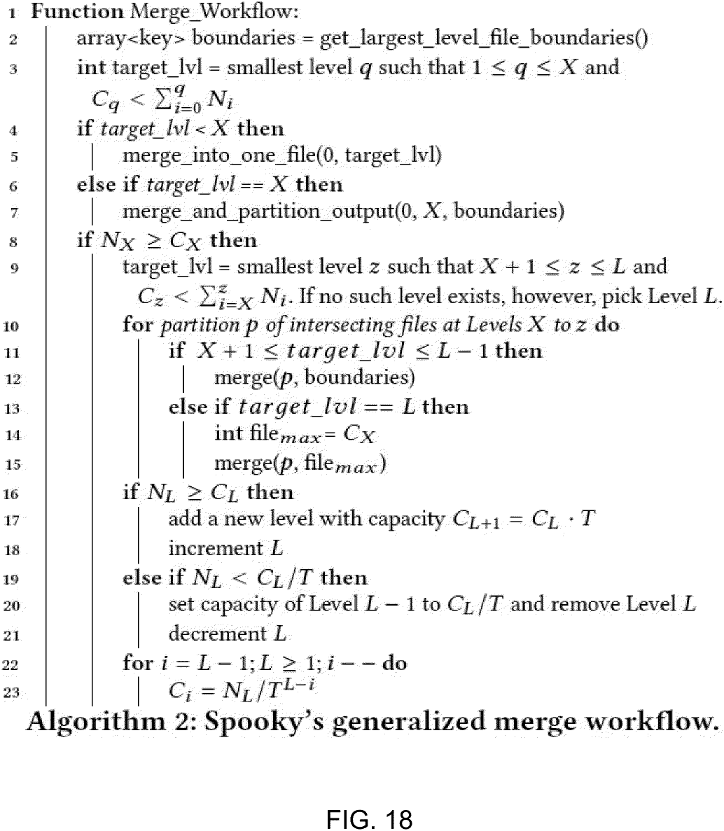

FIG. 18 illustrates an example of method 180 for updating a log structured merged (LSM) tree.

Method 180 may include step 182 of performing preemptive full merge operations at first LSM tree levels.

Method 180 may also include step 184 of performing capacity triggered merge operations at second LSM tree levels while imposing one or more restrictions.

The second LSM tree levels include a largest LSM tree level (for example - the L’th level of FIGS. 8, 10, 11 (before opening a new level below level L), and 12) and one or more other second LSM tree levels (for example level L-1 in FIGS. 8, 10 and other figures) that are larger from each first LSM tree level. In Algorithm 1 there is a single other second LSM tree level (L-1) and in Algorithm 2 there may be more other second LSM tree levels (between L-1’th LSM tree level and L-X’th LSM tree levels). The first LSM tree levels may be the first till (L-2)’th LSM tree levels in FIG. 8, and may be the first till (L-X-1)’th LSM tree levels in Algorithm 2.

Files of the one or more other second LSM tree levels are aligned with files of the largest LSM tree level. Accordingly — a file of an other second LSM tree level overlaps up to a single file of the largest LSM tree level.

The one or more restrictions may limit a number of files that are concurrently written to a non-volatile memory (NVM) during an execution of steps (a) and (b). For example- there may be one file written during step 182 in concurrency with one file written during step 184 and there may be one more file concurrently written from a buffer to the first LSM tree level. Other limitations regarding the number of concurrently written files to the non-volatile memory (NVM) can be imposed. The NVM may be a SSD or other storage entity.

The one or more restrictions impose a writing pattern that includes sequentially writing files of a same LSM tree level to a non-volatile memory (NVM) during an execution of consecutive iterations of steps (a) and (b). A scheduler may schedule the merge operations to include sequential merge operations of a single file and then another sequence of merge operations to another LSM tree level.

The one or more restrictions impose a NVM erasure pattern that includes sequentially evacuating files of the same LSM tree level from the NVM.

The one or more restrictions limit a number of concurrent merged files of the largest LSM tree level and/or to any other second LSM tree level. For example — the limitation may allow a merging of a single largest LSM tree level file at a time. Other limitations may be imposed — for example — less strict limitations on merging may be imposed on smaller other second LSM tree levels. Yet form another example less strict limitations may be applied on the largest LSM tree level.

The files of the largest LSM tree level may be of a same size. This will reduce various penalties. Alternatively — at least two files of the largest LSM tree level may differ from each other by size — by any size difference or any size percentage.

Step 184 may include performing a dividing merge operation (see, for example — section 4.1) that includes merging a first file from a first LSM tree level with a second file of a second LSM tree level that differs from the largest LSM tree level to provide a merged file that belongs to the second LSM tree level.

Step 184 may include a partitioned merge operation that includes merging a file from an other second LSM tree level with a file of the largest LSM tree level to provide one or more merged files that belong to the largest LSM tree level. The size of the merged files may require to split the merged file.

Step 184 may include a hybrid merge operation (see for example FIG. 10B) that includes merging (i) a first file from a first LSM tree level with (ii) a second file of a second LSM tree level that differs from the largest LSM tree level, with (iii) a file of the largest LSM tree level to provide a merged file that belongs to the largest LSM tree level.

Method 180 may include step 186 of evaluating a state of the largest LSM tree level and determining whether to add a new largest LSM tree level to the LSM tree, to elect another second LSM tree level as a new largest LSM tree level or to maintain the largest LSM tree level. See, for example section 4.1 under the title “evolving the tree”.

Step 184 may include avoiding from re-writing a file of the largest LSM tree level, following one or more updates of the LSM tree, when the file of the largest LSM tree level does not overlap with the one or more updates. See, for example, section 4.3.

Method 180 may be applied regardless of the modes of the LSM tree levels. (See, for example section 4.4 and FIG. 12). For example - one or more of the LSM tree levels may operate in a lazy leveling mode and/or one or more of the LSM tree levels may operate in a tiering mode.

Method 180 may include performing a preemptive partitioned merge operation to the largest LSM tree level. See, for example, section 4.2.

### 8 Conclusion

Existing LSM-tree compaction granulation approaches either waste most of the available storage capacity or exhibit a staggering writeamp that cripples performance. We introduce Spooky, the first compaction granulation approach to achieve high storage utilization and moderate write-amp at the same time.

While the foregoing written description of the invention enables one of ordinary skill to make and use what may be considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for updating a log structured merged (LSM) tree, the method comprises:
(a) performing preemptive full merge operations at first LSM tree levels; and
(b) performing capacity triggered merge operations at second LSM tree levels while imposing one or more restrictions; wherein the second LSM tree levels comprise a largest LSM tree level and one or more other second LSM tree levels that are larger from each first LSM tree level; wherein files of the one or more other second LSM tree levels are aligned with files of the largest LSM tree level.

2. The method according to claim 1, wherein the one or more restrictions limit a number of files that are concurrently written to a non-volatile memory (NVM) during an execution of steps (a) and (b).

3. The method according to claim 1, wherein the one or more restrictions impose a writing pattern that comprises sequentially writing files of a same LSM tree level to a non-volatile memory (NVM) during an execution of consecutive iterations of steps (a) and (b).

4. The method according to claim 3, wherein the one or more restrictions impose a NVM erasure pattern that comprises sequentially evacuating files of the same LSM tree level from the NVM.

5. The method according to claim 1, wherein the one or more restrictions limit a number of concurrent merged files of the largest LSM tree level.

6. The method according to claim 1 wherein the files of the largest LSM tree level are of a same size.

7. The method according to claim 1, wherein the capacity triggered merge operations comprise a dividing merge operation that comprises merging a first file from a first LSM tree level with a second file of a second LSM tree level that differs from the largest LSM tree level to provide a merged file that belongs to the second LSM tree level.

8. The method according to claim 1, wherein the capacity triggered merge operations comprise a partitioned merge operation that comprises merging a file from an other second LSM tree level with a file of the largest LSM tree level to provide one or more merged files that belong to the largest LSM tree level.

9. The method according to claim 1, wherein the capacity triggered merge operations comprise a hybrid merge operation that comprises merging (i) a first file from a first LSM tree level with (ii) a second file of a second LSM tree level that differs from the largest LSM tree level, with (iii) a file of the largest LSM tree level to provide a merged file that belongs to the largest LSM tree level.

10. The method according to claim 1, comprising evaluating a state of the largest LSM tree level and determining whether to add a new largest LSM tree level to the LSM tree, to elect another second LSM tree level as a new largest LSM tree level or to maintain the largest LSM tree level.

11. The method according to claim 1, comprising avoiding from re-writing a file of the largest LSM tree level, following one or more updates of the LSM tree, when the file of the largest LSM tree level does not overlap with the one or more updates.

12. The method according to claim 1, wherein one or more of the LSM tree levels operate in a lazy leveling mode.

13. The method according to claim 1, wherein one or more of the LSM tree levels operate in a tiering mode.

14. The method according to claim 1, comprising performing a preemptive partitioned merge operation to the largest LSM tree level.

15. A non-transitory computer readable medium for updating a log structured merged (LSM) tree, the non-transitory computer readable medium comprises:
(c) performing preemptive full merge operations at first LSM tree levels; and
(d) performing capacity triggered merge operations at second LSM tree levels while imposing one or more restrictions; wherein the second LSM tree levels comprise a largest LSM tree level and one or more other second LSM tree levels that are larger from each first LSM tree level; wherein files of the one or more other second LSM tree levels are aligned with files of the largest LSM tree level.

16. The non-transitory computer readable medium according to claim 15, wherein the one or more restrictions limit a number of files that are concurrently written to a non-volatile memory (NVM) during an execution of steps (a) and (b).

17. The non-transitory computer readable medium according to claim 15, wherein the one or more restrictions impose a writing pattern that comprises sequentially writing files of a same LSM tree level to a non-volatile memory (NVM) during an execution of consecutive iterations of steps (a) and (b).

18. The non-transitory computer readable medium according to claim 17, wherein the one or more restrictions impose a NVM erasure pattern that comprises sequentially evacuating files of the same LSM tree level from the NVM.

19. The non-transitory computer readable medium according to claim 15, wherein the one or more restrictions limit a number of concurrent merged files of the largest LSM tree level.

20. The non-transitory computer readable medium according to claim 15 wherein the files of the largest LSM tree level are of a same size.

21. The non-transitory computer readable medium according to claim 15, wherein the capacity triggered merge operations comprise a dividing merge operation that comprises merging a first file from a first LSM tree level with a second file of a second LSM tree level that differs from the largest LSM tree level to provide a merged file that belongs to the second LSM tree level.

22. The non-transitory computer readable medium according to claim 15, wherein the capacity triggered merge operations comprise a partitioned merge operation that comprises merging a file from an other second LSM tree level with a file of the largest LSM tree level to provide one or more merged files that belong to the largest LSM tree level.

23. The non-transitory computer readable medium according to claim 15, wherein the capacity triggered merge operations comprise a hybrid merge operation that comprises merging (i) a first file from a first LSM tree level with (ii) a second file of a second LSM tree level that differs from the largest LSM tree level, with (iii) a file of the largest LSM tree level to provide a merged file that belongs to the largest LSM tree level.

24. The non-transitory computer readable medium according to claim 15, that stores instructions for evaluating a state of the largest LSM tree level and determining whether to add a new largest LSM tree level to the LSM tree, to elect another second LSM tree level as a new largest LSM tree level or to maintain the largest LSM tree level.

25. The non-transitory computer readable medium according to claim 15, that stores instructions for avoiding from re-writing a file of the largest LSM tree level, following one or more updates of the LSM tree, when the file of the largest LSM tree level does not overlap with the one or more updates.

26. The non-transitory computer readable medium according to claim 15, wherein one or more of the LSM tree levels operate in a lazy leveling mode.

27. The non-transitory computer readable medium according to claim 15, wherein one or more of the LSM tree levels operate in a tiering mode.

28. The non-transitory computer readable medium according to claim 15, that stores instructions for performing a preemptive partitioned merge operation to the largest LSM tree level.

29. A log structured merged (LSM) tree updating unit, wherein the LSM tree updating unit comprises one or more circuits that are configured to update the LSM tree, by:
(a) performing preemptive full merge operations at first LSM tree levels; and
(b) performing capacity triggered merge operations at second LSM tree levels while imposing one or more restrictions; wherein the second LSM tree levels comprise a largest LSM tree level and one or more other second LSM tree levels that are larger from each first LSM tree level; wherein files of the one or more other second LSM tree levels are aligned with files of the largest LSM tree level.
